(19) United States
(12) Patent Application Publication
(10) Pub. No.: US 2019/0351367 A1
(43) Pub. Date: Nov. 21, 2019

(54) ACTIVE PROTECTION

(71) Applicant: Osmotex AG, Thalwil (CH)

(72) Inventors: Trond Heldal, Luzern (CH); Stephanie Say-Liang-Fat, Zurich (CH)

(73) Assignee: Osmotex AG, Thalwil (CH)

(21) Appl. No.: 16/475,833

(22) PCT Filed: Jan. 3, 2018
(86) PCT No.: PCT/EP2018/050151

§ 371 Date: Jul. 3, 2019

(30) Foreign Application Priority Data
Jan. 5, 2017 (GB) 1700093.6

(51) Int. Cl. B01D 53/32; B01D 53/22; B01D 63/00; A41D 31/102; E04B 1/62; B01L 3/00

(52) U.S. Cl. CPC B01D 53/323; B01D 53/228; B01D 63/00; A41D 31/102; B01L 2400/0627; B01L 3/502738; B01D 2313/345; B01D 2313/365; E04B 1/625

(57) ABSTRACT

A method of operating a membrane is provided. The membrane comprises: a porous layer; a first electrically conductive layer located on a first side of the porous layer; and a second electrically conductive layer located on a second side of the porous layer. When an electric voltage is applied between the first and second electrically conductive layer across the porous layer, the membrane prevents moisture intrusion from a first surface of the membrane towards a second surface of the membrane. The method comprises applying an electric voltage between the first and second electrically conductive layer across the porous layer to prevent moisture intrusion from the first surface of the membrane towards the second surface of the membrane when it is desired to prevent moisture intrusion from the first surface towards the second surface. A membrane system for performing the method is also provided.

The invention relates to a membrane which can be used to prevent moisture intrusion into and/or through the membrane and a method of operating such a membrane.

In many applications, such as outdoor clothing, it is desired to have a breathable membrane so as to, for example, give a high degree of comfort to the user. However, often it is also desired for such membranes to be waterproof.

The human body, particularly during physical activity, exudes perspiration that it is desirable is carried away from the skin in order to ensure thermal comfort. Many textiles, in particular those suitable for waterproof and protective garments, have however little ability to transport moisture, and can therefore lead to overheating or heat losses when humidity saturates the fibres of a garment and reduce its thermal insulation.

Modern pieces of clothing make use of so called ‘breathable’ fabrics that allow the passage of water vapour while remaining waterproof. Such materials rely on passive transport of water as water vapour and their effectiveness reduces with the increase of the external humidity.

It is known to exploit the phenomena of electroosmosis or other electrokinetic effects to actively transport water through a membrane, even against a pressure gradient or a concentration gradient. A piece of porous material is sandwiched between two conductive electrodes that are connected to a suitable energy source. The electric field in the porous layer induces motion of the fluid within the membrane, effectively pumping it from one side of the membrane to the other.

However, such a method of transporting liquid through a membrane requires a constant power source and as such may not always be a suitable solution for transporting fluid through a membrane.

In a first aspect, the present invention provides a method of operating a membrane, the membrane comprising: a porous layer; a first electrically conductive layer located on a first side of the porous layer; and a second electrically conductive layer located on a second side of the porous layer; wherein, when an electric voltage is applied between the first and second electrically conductive layer across the porous layer, the membrane prevents moisture intrusion from a first surface of the membrane towards a second surface of the membrane, and wherein the method comprises applying an electric voltage between the first and second electrically conductive layer across the porous layer to prevent moisture intrusion from the first surface of the membrane towards the second surface of the membrane when it is desired to prevent moisture intrusion from the first surface towards the second surface.

The first surface may be the surface that the first side of the porous layer faces and/or the second surface may be the surface that the second side of the porous layer faces.

It has recently been discovered that membranes (e.g. in textiles) that are designed to transport liquid by aid of an electric voltage (which may be referred to as an active membrane) can have very good passive transport of water through the membrane. This may be liquid and/or vapor transport without applying the electric voltage. These active membranes may in fact have passive transport that is better than known ‘breathable’ fabrics such as Gore-Tex. Especially, under circumstances where condensation of water vapour can happen on/at/near the second surface of the membrane side (which may for example be the surface pointing towards the wearer), the membranes of the invention may allow both liquid and vapour (i.e. not only vapor transport) through the membrane.

However, the membranes that may provide good passive transport of liquid may not have sufficient waterproofness for a user's need. It has been realised that an active membrane can have an electric voltage applied when it is required for the membrane to be waterproof (i.e. more waterproof), i.e. when it is desired to prevent moisture intrusion into the membrane. As a result, the power requirements of the membrane may be significantly reduced compared to a membrane that a voltage is applied to transport liquid through the membrane rather than to stop it entering the membrane in the first place.

The usual way of operating an active membrane/textile would be to apply a voltage to cause transport of water through the membrane from a second side to a first side. In contrast the present invention is concerned with applying a voltage when it is desired to prevent ingress of water from the first side to the second side. In the present invention, liquid may pass through the membrane from the second side to the first side passively (i.e. without the application of a voltage).

In the present invention the voltage may not be applied to transport water through the membrane. Voltage may be applied when better protection is needed from moisture on one side of the membrane (the downstream side relative to fluid flow that would be induced by applying a voltage across the membrane). This may for example be when rain, or other liquid, hits the downstream side or the downstream side is in contact with a wet surface or water for example.

Because liquid may not be pumped through the membrane but merely stopped from entering and/or the voltage may only be applied in certain conditions when liquid ingress needs to be stopped, the energy consumption of the product may be lower and/or there may be less wear on the conductive layers (i.e. electrodes) and the porous layer.

It has been demonstrated that the application of voltage can increase the waterproofness of an active membrane. The waterproofness may be measured as the maximum water column or kinetic energy of rain the membrane can withstand without leaking.

The method may comprise applying an electric voltage between the first and second electrically conductive layer across the porous layer to prevent moisture intrusion from the first surface of the membrane towards the second surface of the membrane when protection at the second surface is required/desired from liquid at the first surface of the membrane.

The membrane may be a textile.

The membrane may be a layered structure made up of a plurality of layers.

The membrane may be a porous membrane. The electrically conductive layers may be electrically conductive porous layers.

The electrically conductive layers may be textiles laminated on each side of the porous layer.

The porous layer may be a non-conductive layer.

The membrane may be an active membrane such as an electroosmotic or electrokinetic membrane.

The electroosmotic membrane may be any structure, such as a fabric, for pumping fluid by electroosmotic transport.

The mechanism for preventing water ingress may be due to electrostatic repulsion, electroosmotic pressure with zero electroosmotic flow, and/or electroosmotic flow.

The first surface may face a first environment and/or the second surface may face a second environment.

The first environment may be an external environment and/or the second environment may be an internal environment.

For example, if the membrane forms an item of clothing or is part of an item of clothing, the second surface may, in use, face towards the user's (i.e. the wearer's) body. The second surface may be closer to the user's body in use than the first surface. The first environment may be outside of the item of clothing and the second environment may be inside the item of clothing.

The method may comprise applying an electric voltage between the first and second electrically conductive layer across the porous layer to prevent moisture intrusion from the first surface of the electroosmotic membrane towards the second surface of the electroosmotic membrane when a certain condition is sensed. This may be a certain condition in the first environment and/or in the membrane itself.

The negative polarity of the applied electric voltage may be applied to the first electrically conductive layer.

The method may comprise sensing a condition. The condition may be one or more of humidity, temperature, conductivity, impedance, detection of water, moisture and/or rain, the weather, acceleration, deceleration, speed, orientation, pressure etc. The sensed condition may be the membrane being in contact with a surface such as the ground or a wet object.

These conditions may be sensed by the user and/or one or more sensors. The sensor(s) may comprise one or more of a humidity sensor, temperature sensor, moisture sensor, accelerometer, magnetometer, proximity sensor, pressure sensor, chemical sensor etc.

One or more of the sensor(s) may be provided by the active membrane itself. Thus, the active membrane and/or one or both of the conductive layers may be arranged so that it can be used as a sensor.

For example, the electrical impedance of the membrane may depend on its moisture content. This may be due to an increase in conductivity and/or capacitance. The impedance may be measured at the same connectors as those providing the electric voltage for inducing moisture transport in the membrane.

The sensor may be provided by a measuring circuit that measures the electrical impedance of the membrane. The impedance measured by the measuring circuit may depend on the moisture conditions between the conductive layers.

The sensor may be for identifying when a substance is entering the membrane from the first surface of the membrane towards the second surface of the membrane.

The substance may be a liquid and/or a liquid borne substance.

The voltage may be applied automatically in response to a sensed condition.

The voltage may be automatically applied in response to a signal from a sensor.

The electric voltage may be applied in response to a condition sensed in the first environment and/or in response to a condition sensed indicative of the first environment.

This condition may be sensed by the user and the electric voltage may then be switched on manually. The condition may be sensed by a sensor. When the condition is sensed by the sensor the electric voltage may be switched on automatically. Alternatively or additionally, when the condition is sensed by the sensor the user may be alerted and then the electric voltage may then be switched on manually.

The voltage may be applied in response to a signal from a sensor.

The moisture may be rain water

The condition sensed may be that it is raining.

The voltage may be applied to prevent intrusion of rain water.

The voltage may be applied to protect from aerosols or water containing toxic matter.

For example, it may be desired to prevent moisture intrusion from the first surface towards the second surface when it is raining in the first environment.

The voltage may be applied manually in response to a sensed condition, such as it starting to rain and/or the material coming into contact with a wet surface such as the ground.

The membrane may be part of a device that comprises a power source, a controller, and/or one or more sensors. The membrane may comprise and/or be connected to one or more of a power source, a controller, and/or one or more sensors.

The membrane and/or device may comprise a circuit for connection to the power source that allows the supply of electric voltage across the porous membrane.

The membrane (e.g. controller) may be controlled from an external device such as a smart phone, a smart watch, a remote computer etc. The controller may be part of an external device such as a smart phone, a smart watch, a remote computer etc.

For example, the control system may be controlled from a smart phone app.

The power source, controller, and/or one or more sensors may be provided by an external portable consumer device such as a smart phone, a smart watch etc.

In a second aspect, the present invention may provide a membrane system comprising: a membrane comprising a porous layer; a first electrically conductive layer located on a first side of the porous layer; and a second electrically conductive layer located on a second side of the porous layer; and a circuit for applying an electric voltage between the first and second electrically conductive layer across the porous layer; and a sensor for identifying a condition when it is desired to prevent moisture intrusion from the first surface towards the second surface; wherein the circuit is controlled based on an output from the sensor, and wherein when an electric voltage is applied between the first and second electrically conductive layer across the porous layer, the membrane prevents moisture intrusion from the first surface of the membrane towards the second surface of the membrane.

The membrane and/or a device that the membrane may be part of (which each may be referred to as a membrane system) may be arranged to apply an electric voltage between the first and second electrically conductive layers across the porous layer to prevent moisture intrusion from the first surface of the membrane towards the second surface of the membrane when it is desired to prevent moisture intrusion from the first surface towards the second surface (e.g. based on the output of the sensor).

The membrane and/or membrane system comprising the membrane may comprise any one or more of the features (including both the essential and optional features) disclosed above and the membrane of the method of the first aspect may be the membrane of the second aspect and/or comprise one or more of the features (including both the essential and optional features) disclosed herein.

The sensor may be for identifying when a substance (e.g. a liquid such as rain and/or water) is entering the membrane from the first surface of the membrane towards the second surface of the membrane.

The first electrically conductive layer, the second electrically conductive layer and/or the porous layer may be hydrophobic. The first electrically conductive layer has a surface that may be hydrophobic. The hydrophobic surface may be the surface that is furthest from the porous layer, i.e. the surface that faces or is nearest an external environment from which it is desired to protect from the intrusion of moisture.

The porous layer may comprise hydrophobic surface coatings on at least one side. For example, there may be a hydrophobic surface coating on the first surface of the porous layer.

The porous layer may have hydrophobic pore walls.

The porous layer may have pores smaller than 500 nm, or less than 5 nm. For example, the pore size may be 0.1 to 200 nm. For example the pore size may be 0.1 to 2 nm (for example in biohazard protection or in other extreme protection applications). The pore size may be 2-200 nm. This may be the pore size when only more moderate protection is required.

The bigger the pore size the better the passive transport of liquid through the membrane. The passive transport may for example be breathability which may be vapour transport through the membrane and/or liquid transport through the membrane. However, the waterproofness (i.e. barrier to water ingress) is also reduced with increasing pore size. The present invention may allow the membrane to have a pore size which is large enough to give sufficient passive water transport through the membrane, e.g. from the second surface to the first surface, whilst having the required waterproofness at the appropriate time when the voltage is applied. The membrane may allow efficient removal of condensation which may happen on the inside of the membranes, e.g. in cold weather. The condensation may pass through the membrane.

For a membrane with a given pore size, the application of an electric field (i.e. by applying a voltage across the porous membrane) will increase the waterproofness of the membrane relative to the passive waterproofness (i.e. waterproofness when no electric voltage is applied). The present invention may thus provide a combination of high passive breathability and waterproofness that is not achievable with conventional membranes.

The passive breathability may be driven by a vapour pressure gradient across the membrane. The passive water transport and transport of condensation (i.e. liquid transport) may be driven by capillarity combined with evaporation at the outside of the garment.

The membrane may have very high passive breathability and passive liquid transport, provide active pumping of liquid through the membrane (such as condensation and/or sweat) when a voltage is applied across the membrane and/or active protection from the outside when a voltage is applied.

The prevention of water ingress may occur through one or more different mechanisms. These may be 1) repelling the moisture before it enters the pores of the porous layer. This may be achieved by hydrophobic repulsion of moisture by the membrane. 2) when water is just reaching the second conductive layer, electroosmotic repulsion pushing back of the moisture (a fast process where the second conductive layer (i.e. electrode) acts as repulsing the water) and/or 3) if water (e.g. at higher pressure) gets into the second conductive layer, porous layer and/or first conductive layer, dewatering of the layers by electroosmotic transport which may avoid water flowing further into the membrane.

The porous layer may be flexible.

The porous layer may be a polymer porous layer.

The porous layer may have a negative surface charge when wetted.

The porous layer may comprise ionic groups to carry the current, e.g. sulfonic acid groups.

The porous layer may be about 5 to 500 micron, or about 10-120 microns thick (i.e. the dimension through the membrane substantially in the direction of the net fluid flow).

The membrane may be combined with fabric layers to form a textile. For example, a wicking layer may be provided on one (such as the second surface) or both surfaces of the active membrane.

The first electrically conductive layer and/or the second electrically conductive layer may be fabric layers with 1 to 30 wt percent conductive yarn. For example the conductive yarn may be silver coated polyester or steel yarn.

The first electrically conductive layer and/or the second electrically conductive layer may be coated with a capacitive coating.

The membrane may be used in clothing, such as a jacket. The clothing may be outdoor clothing, sports, leisure and/or work clothing. The membrane may be used to give better performance and comfort to the wearer.

The membrane may be used in protective clothing such as bacteriological protective clothing, chemically protective clothing, firefighting uniforms and/or armour/ballistic protection. For example, known biohazard suits must in some cases be changed every hour to avoid suffocation, due to a total lack of breathability. With the present invention it may be possible for the protective clothing to be breathable and then for the protective element to only be applied by application of a voltage when required, e.g. when a certain condition is sensed either by a user or a sensor.

The membrane may be used in buildings such as in a cellar. The membrane may be used to prevent seepage in cellars. In this case, the energy consumption of the device may be negligible compared to a system that is used for pumping liquid. In other words, the membrane does not pump water out of the building but prevents it from entering in the first place. This may be achieved with the application of a constant low voltage and/or when a certain moisture/humidity level is detected.

The membrane may provide/be used as a valve in a microfluidic and/or micromechanical system (e.g. for volume control in fluidic lenses).

The membrane may be used as a vent in applications such as medical wearable devices, electronic devices (e.g. where moisture should be avoided to reduce corrosion), and automotive applications (for example vents on headlights to avoid condensation on the glass). The membrane may be used instead of passive porous vents.

When the voltage is applied to prevent moisture intrusion from the first surface towards the second surface, the membrane may also transport liquid in a direction from the second surface to the first surface by an electrokinetic effect such as electroosmosis. For example, the membrane may be arranged to have active transport rates in a direction from the second surface towards the first surface from 0.5 to 10 litre/m² hour when a voltage is applied across the porous membrane.

However, it is not essential for active transport to occur through the membrane to prevent moisture intrusion. For example, the application of the voltage may prevent moisture instruction from the first side to the second side without any transport of liquid from the second side to the first side. The application of the electric voltage may cause electrostatic repulsion and/or electroosmotic pressure without any electroosmotic flow. In many cases the combination of active protection and passive breathability (vapour) and passive liquid transport may be sufficient.

For example, A4 sized panels of the membrane were integrated as windows in ski jackets formed of state of the art conventional membranes. The modified ski jacket was tested in cool weather (+5 C) and at moderate activity level and sweat rates of about 400 g/person hour. It was found after 1 hour, that ample condensation with droplet formation was visible on the state of the art conventional membrane used in the un-modified parts of the jacket, whereas no condensation was visible on the active protective fabric window. It was found that the same membrane was waterproof to a water column of up to 70 cm by applying a voltage of less than 4 V.

The present invention may allow the use of textiles and membranes with higher porosities and/or larger pores than would otherwise be possible for a given desired level of waterproofness or protection from the environment. The present invention may permit a better compromise between moisture transport through the membrane and protection than is possible with current known materials/textiles.

As another example, the present invention may be used in ski clothing such as a ski jacket. The voltage may be applied when a condition is detected such as it is snowing, the user has fallen over and/or the outside of the jacket is touching a wet surface. This may mean that during skiing when it is not snowing and the user is not touching another surface no voltage is applied but if it starts snowing, the user falls over or touches a wet surface a voltage may be applied to prevent intrusion of water from outside the ski clothing to inside the clothing near the wearer's body.

Certain preferred embodiments of the present invention will now be described by way of example only with reference to the accompanying drawings, in which:

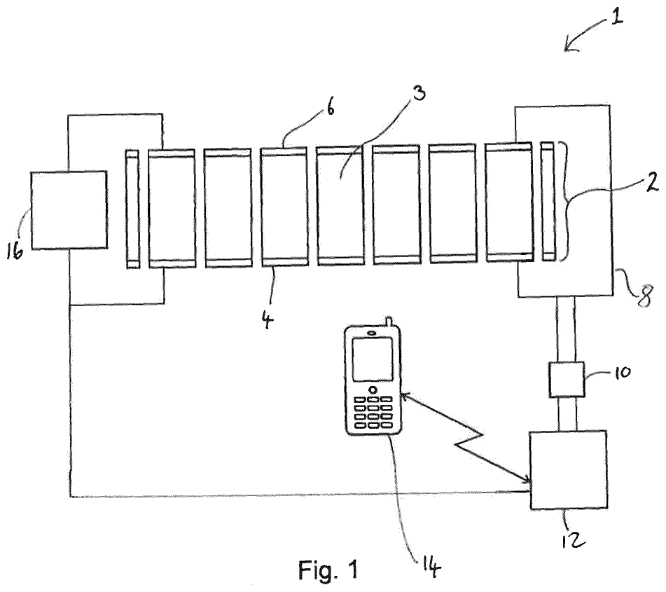

FIG. 1 is a schematic of a system incorporating an active membrane.

FIG. 1 shows a system 1 with a porous membrane 2 that comprises a porous layer 3; a first porous electrically conductive layer 4 located on a first side of the porous layer 3; and a second porous electrically conductive layer 6 located on a second side of the porous layer 3.

When an electric voltage is applied between the first and second electrically conductive layers 4, 6 across the porous layer 3, the membrane 2 prevents moisture intrusion from a first surface of the membrane 2 (i.e. the side on which the first conductive layer 4 is located) towards a second surface of the membrane 2 (i.e. the side on which the second conductive layer 6 is located).

The membrane 2 may be operated so that an electric voltage is applied between the first and second electrically conductive layers 4, 6 across the porous layer 3 to prevent moisture intrusion from the first surface of the membrane 2 towards the second surface of the membrane 2 when it is desired to prevent moisture intrusion from the first surface towards the second surface.

The system comprises a circuit 8 that allows the supply of electric voltage across the porous membrane 2. The circuit 8 is connected to a power source 10.

The power source 10 may be connected to a controller 12. The controller 12 may control the power source 10 so that an electric voltage is applied between the first and second electrically conductive layers 4, 6 across the porous layer 3 to prevent moisture intrusion from the first surface of the membrane 2 towards the second surface of the membrane 2 when it is desired to prevent moisture intrusion from the first surface towards the second surface.

This may be achieved by a user determining when it is desired to prevent moisture intrusion from the first surface towards the second surface and applying a voltage across the membrane 2 using the circuit 8 and power source 10 to prevent the moisture intrusion. The user may cause the application of a voltage across the membrane 2 using the power source 10 and/or the controller 12. The control may be direct or remote, such as from an external device 14.

The system 1 may alternatively or additionally be set up as shown in FIG. 1 to allow automatic application of a voltage across the membrane 2 when it is desired to prevent moisture intrusion from the first surface towards the second surface.

The system 1 may comprise a sensor 16 for detecting when it is desired to prevent moisture intrusion from the first surface towards the second surface.

The sensor 16 may provide an input to the controller 12 that allows it to be determined when a condition has occurred that means that it is desired to prevent moisture intrusion from the first surface towards the second surface.

1. A method of operating a membrane, the membrane comprising:
a porous layer;
a first electrically conductive layer located on a first side of the porous layer; and
a second electrically conductive layer located on a second side of the porous layer; and
wherein, when an electric voltage is applied between the first and second electrically conductive layer across the porous layer, the membrane prevents moisture intrusion from a first surface of the membrane towards a second surface of the membrane, and
wherein the method comprises applying an electric voltage between the first and second electrically conductive layer across the porous layer to prevent moisture intrusion from the first surface of the membrane towards the second surface of the membrane when it is desired to prevent moisture intrusion from the first surface towards the second surface.

2. A method according to claim 1, wherein the method comprises applying an electric voltage between the first and second electrically conductive layer across the porous layer to prevent moisture intrusion from the first surface of the electroosmotic membrane towards the second surface of the electroosmotic membrane when a certain condition is sensed.

3. A method according to claim 1 or 2, wherein the method comprises sensing a condition.

4. A method according to claim 3, wherein the condition is a condition in a first environment which faces the first electrically conductive layer.

5. A method according to claim 2, 3 or 4, wherein the condition is one or more of humidity, temperature, conductivity, impedance, detection of water, moisture and/or rain, the weather, acceleration, deceleration, speed, orientation, pressure.

6. A method according to any of claims 2 to 5, wherein the condition is sensed by a user and the electric voltage is switched on manually.

7. A method according to any of claims 2 to 6, wherein the condition is sensed by one or more sensors.

8. A method according to claim 7, wherein the sensor(s) comprises one or more of a humidity sensor, temperature sensor, moisture sensor, accelerometer, magnetometer, proximity sensor, pressure sensor, chemical sensor.

9. A method according to claim 7 or 8, wherein the one or more of the sensor(s) is provided by the membrane itself.

10. A method according to any preceding claim, wherein the voltage is automatically applied in response to a signal from a sensor.

11. A method according to any preceding claim, wherein the membrane is an electroosmotic and/or electrokinetic membrane.

12. A method according to any preceding claim, wherein the membrane comprises, is part of a device that comprises, and/or is connected to a device that comprises a power source, a controller, and/or one or more sensors.

13. A method according to claim 12, wherein the power source, controller, and/or one or more sensors are provided by an external portable consumer device.

14. A method according to any preceding claim, wherein the mechanism for preventing water ingress is electrostatic repulsion, electroosmotic pressure with zero electroosmotic flow, and/or electroosmotic flow.

15. A method according to any preceding claim, wherein the first electrically conductive layer has a surface that is hydrophobic, and wherein the hydrophobic surface is the surface that is furthest from the porous layer.

16. A method according to any preceding claim, wherein the porous layer has pores smaller than 500 nm.

17. A method according to any preceding claim, wherein the porous layer is a polymer porous layer.

18. A method according to any preceding claim, wherein the porous layer has a negative surface charge when wetted.

19. A method according to any preceding claim, wherein the voltage is applied to prevent intrusion of rain water.

20. A method according to any preceding claim, wherein the membrane is used in clothing.

21. A method according to any preceding claim, wherein the membrane is used in a building.

22. A method according to any preceding claim, wherein the membrane is used as a valve in microfluidic system or a vent.

23. A membrane system comprising:
a membrane comprising: a porous layer; a first electrically conductive layer located on a first side of the porous layer; and a second electrically conductive layer located on a second side of the porous layer;
a circuit for applying an electric voltage between the first and second electrically conductive layer across the porous layer; and
a sensor for identifying a condition when it is desired to prevent moisture intrusion from the first surface towards the second surface;
wherein the circuit is controlled based on an output from the sensor, and
wherein when an electric voltage is applied between the first and second electrically conductive layer across the porous layer, the membrane prevents moisture intrusion from the first surface of the membrane towards the second surface of the membrane.

24. A membrane system according to claim 23, wherein the sensor comprises one or more of a humidity sensor, temperature sensor, moisture sensor, accelerometer, magnetometer, proximity sensor, pressure sensor, chemical sensor.

25. A membrane system according to claim 23 or 24, wherein the one or more of the sensors is provided by the membrane itself.

26. A membrane system according to claim 23, 24 or 25, wherein the voltage is automatically applied in response to a signal from a sensor.

27. A membrane system according to any of claims 23 to 26, wherein the membrane is an electroosmotic and/or electrokinetic membrane.

28. A membrane system according to any of claims 23 to 27, wherein the membrane comprises, is part of a device that comprises, and/or is connected to a device that comprises a power source, a controller, and/or the one or more sensors.

29. A membrane system according to claim 28 wherein the power source, controller, and/or one or more sensors are provided by an external portable consumer device.

30. A membrane system according to any of claims 23 to 29, wherein the first electrically conductive layer has a surface that is hydrophobic, and wherein the hydrophobic surface is the surface that is furthest from the porous layer.

31. A membrane system according to any of claims 23 to 30, wherein the porous layer has pores smaller than 500 nm.

32. A membrane system according to any of claims 23 to 31, wherein the porous layer is a polymer porous layer.

33. A membrane system according to any of claims 23 to 32, wherein the porous layer has a negative surface charge when wetted.

34. A membrane system according to any of claims 23 to 33, wherein the membrane is part of an item of clothing.

35. A membrane system according to any of claims 23 to 33, wherein the membrane is provided in a building.

36. A membrane system according to any of claims 23 to 33, wherein the membrane is a valve in microfluidic system or a vent.

37. A membrane system of any of claims 23 to 36, wherein the membrane is operated according to the method of any of claims 1 to 22.

38. A method according to any of claims 1 to 22, wherein the membrane is the membrane that is part of the membrane system of any of claims 22 to 37.
